(19) United States
(12) Patent Application Publication
(10) Pub. No.: US 2006/0247345 A1
(43) Pub. Date: Nov. 2, 2006

(54) Adhesive composition

(76) Inventor: Jouni Rainio, Puhos (FI)

Correspondence Address: RESOLUTION PERFORMANCE PRODUCTS LLC;ATTN: LISA JONES, 1600 SMITH STREET, P.O. BOX 4500, HOUSTON, TX, 77210-4500, US

(21) Appl. No.: 10/549,544

(22) PCT Filed: Mar. 26, 2004
(86) PCT No.: PCT/FI04/00177

§ 371 Date: Jun. 2, 2006

(30) Foreign Application Priority Data
Mar. 28, 2003 (FI) 20030466

(51) Int. Cl. C08K 5/41; B29C 47/00

(52) U.S. Cl. 524/155; 524/13; 524/47; 524/423; 524/425

(57) ABSTRACT

An adhesive composition for use in the manufacture of wood-based boards, said adhesive composition containing resin and a foaming agent, and said composition being foamable. According to the invention, the adhesive composition contains 40-80 w-% resin, 5-30 w-% filler, 0-40 w-% solvent, and 0.1-10 w-% foaming agent, which has been selected from organic and/or inorganic surface-active sulfate, sulfonate, phosphate or phosphonate compounds or their derivatives or mixtures.

The present invention relates to an adhesive composition as defined in the preamble of claim 1, designed for use in the manufacture of wood-based sheets, such as plywood, scaleboard, blackboard, fibreboard, OBS board or equivalent.

In the present context, plywood refers to plywood, chipboard or a corresponding multi-layer product formed form at least three veneer layers placed one upon the other or crosswise and glued and pressed against each other to form plywood, chipboard or equivalent.

In prior art, various adhesives for use in woodboard industry are known. An example of known technology is the use of phenolic resin glues, such as phenol-formaldehyde resin, or urea resin glues as adhesives. Another known technique is to add a foaming agent to an adhesive in order to foam the adhesive composition before its delivery for application in the gluing of woodboard. A preferred known foaming agent used is dried blood. A problem with the use of dried blood are the ethical questions involved. Moreover, when dried blood is used, it may be necessary to add a separate surface tension reducing agent to the adhesive composition in order to achieve the desired properties. A further problem in the use of dried blood is that it is added to the filler or hardener of the adhesive composition in a powdery form, which is why it is difficult to achieve a perfect homogeneity of the composition.

Various other adhesive compositions not containing dried blood as a foaming agent have also been tried in woodboard industry. However, so far no composition of sufficient quality and efficiency has been found that contains no dried blood and has gluing properties and a price and durability suited for use in the manufacture of wood-based boards.

A further problem in the use of prior-art adhesive compositions is their poor durability, which is why the compositions have to be mixed just before use. In addition, the adhesive concentration in prior-art compositions is conventionally low, and therefore eventual impurities can contaminate the adhesive composition more easily.

The object of the present invention is to overcome the above-mentioned drawbacks concerning an adhesive composition in connection with the manufacture of wood-based boards. A specific object of the invention is to disclose a new; more effective and more ethical adhesive composition.

The adhesive composition of the invention is characterized by what is disclosed in the claims.

The invention is based on an adhesive composition used in the manufacture of wood-based boards. The adhesive composition contains resin, a filler, a foaming agent and a solvent, and it is foamable. According to the invention, the adhesive composition contains 40-80 w-% resin, 5-30 w-% filler, 0-40 w-% solvent and 0.1-10 w-% foaming agent, which has been selected from organic and/or inorganic surface-active sulfate, sulfonate, phosphate or phosphonate compounds or their derivatives or their mixtures.

In an embodiment of the invention, the foaming agent used is lauryl sulfate, lauryl ether sulfate or benzene sulfate or a compound, derivative or mixture of these or the like. In an embodiment, the lauryl sulfate or lauryl ether sulfate has been selected from the group: sodium lauryl sulfate, ammonium lauryl sulfate, potassium lauryl sulfate, sodium lauryl ether sulfate, ammonium lauryl ether sulfate, potassium lauryl ether sulfate, a derivative of these or a mixture of these or the like.

In an embodiment of the invention, the foaming agent used is a substance selected from the group: sodium isopropyl sulfonate, sodium lauryl sulfonate, sodium benzene sulfonate, sodium alkyl benzene sulfonate, ammonium lauryl phosphate, ammonium lauryl sulfonate, potassium olein sulfate, sodium naphthalene sulfonate or a compound, derivative or mixture of these or the like.

Alternatively, it is possible to use any corresponding surface-active compound as a foaming agent. In this connection, the purpose of the surface-active compound is expressly to promote its foaming.

In a preferred embodiment of the invention, the adhesive composition contains 0.1-5 w-% foaming agent.

In a preferred embodiment, the adhesive composition contains 1-10 w-% foaming agent, of which 0.1-30 w-% is lauryl sulfate, lauryl ether sulfate, benzene sulfate or their compounds, derivatives or mixtures.

In an embodiment of the invention, the resin, i.e. the actual adhesive used may preferably consist of phenol-formaldehyde resins, urea-formaldehyde resins, amino resins or other corresponding resins. In an embodiment, the resin used is UF (urea-formaldehyde resin), MUF (melamine urea-formaldehyde), MUFP, PF (phenol-formaldehyde), PMF or PRF or a derivative or mixture of these or equivalent.

In a preferred embodiment of the invention, the adhesive composition contains 50-70 w-% resin.

In an embodiment of the invention, the adhesive composition contains a filler, preferably in an amount of 8-20 w-%.

In this context, filler refers to a filling agent or hardener known in itself or to a mixture of these. The hardener effects the hardening of the glue in the application, i.e. during the manufacturing of wood-based boards, often preferably together with heat of compression. In an embodiment, the filler used is starch, wheat flower, chalk, sodium carbonate, potassium carbonate, calcium carbonate, ammonium sulfate, wood powder, quebracho or a derivative of these or a mixture of these or equivalent. Quebracho means the hard wood material of certain South-American broadleaf trees. Chalk in this connection refers to loose-structured, light and crumbling limestone.

In an embodiment of the invention, the adhesive composition contains a solvent, preferably in an amount of 12-35 w-%. In a preferred embodiment, the solvent is water. The water may be obtained from outside the process or it may be water circulated from within the process, i.e. process wash water. In an alternative embodiment, the solvent is an organic solvent.

In an embodiment of the invention, the adhesive composition contains air, preferably pressurized air, added to it to achieve more effective formation of foam.

In an embodiment, the adhesive composition contains a separate surface-active substance not intended purely for the purpose of foaming, preferably in an amount of 0.1-2 w-%.

In an embodiment, the adhesive composition contains a catalyst.

In a preferred embodiment of the invention, the foaming agent is in solid, liquid or paste-like state. In an embodiment, the foaming agent is added as such or in the form of a solution into the adhesive composition.

In a preferred embodiment, the adhesive composition is an emulsion. In an embodiment of the invention, the adhesive composition has been formed by mixing the resin, filler, foaming agent and solvent together to produce an emulsion, e.g. a water emulsion. In an embodiment, the resin, filler, foaming agent and solvent are mixed at a high temperature, e.g. over 40° C.

In an embodiment, the mixture or emulsion has a high adhesive concentration.

The invention makes it possible to produce a more effective and more ethical adhesive composition. The invention has the advantage that a composition having a very good foamability and allowing a very good control of foamability is achieved.

According to the invention, the adhesive composition contains resin, a foaming agent, a solvent and/or a filler; no separate additives are needed. A further advantage of the invention is that the foaming agent is in liquid phase, allowing a very homogeneous adhesive composition to be produced when the components forming the composition are mixed to form a liquid adhesive mixture.

A further advantage of the invention is that the adhesive has a good and fast spreadability on the surface to be glued. The adhesive is not viscous and it divides easily when being spread. This means a reduced consumption of adhesive.

An additional advantage of the adhesive composition is good durability because adhesive concentration of the composition is substantially higher than in prior-art adhesives and in addition because the adhesive mixture or emulsion has been preferably formed by mixing the liquid components together and cooking the mixture preferably at a relatively high temperature (over 40° C.). The adhesive composition is preserved substantially unchanged for as long as several weeks. Moreover, the composition is not sensitive to impurities, microbes or equivalent.

The adhesive composition of the invention is applicable for use in the manufacture of various wood-based boards in different conditions.

In the following, the invention will be described with reference to detailed embodiment examples.

### EXAMPLE 1

In an experiment, an adhesive composition was prepared. Phenol formaldehyde resin (52 w-%), filling agent (8.7 w-%) and ammonium lauryl sulfate (1.7 w-%) and a solvent (water, 37.3 w-%) were mixed together to form a water mixture. The filling agent was a mixture of calcium carbonate, starch and wheat meal.

The mixture thus produced had good foaming characteristics.

### EXAMPLE 2

In an experiment, an adhesive composition as in Example 1 was prepared in a corresponding manner. As an exception to Example 1, the ammonium lauryl sulfate used in this experiment was added directly as a water emulsion. The mixture had a composition corresponding to Example 1. The mixture produced had foaming characteristics substantially as good as those of the mixture in Example 1.

### EXAMPLE 3

In an experiment, phenol formaldehyde resin (50 w-%), filling agent (10 w-%) (as in Example 1), sodium alkyl benzene sulfonate (5.2 w-%) and a solvent (water, 34, 8 w-%) were mixed together. The mixture thus produced had a good foamability.

### EXAMPLE 4

In an experiment, an adhesive composition as in Example 3 was prepared. As an exception to Example 3, the foaming agent used in this experiment was a mixture of sodium alkyl benzene sulfonate and ammonium lauryl sulfonate. In this case, the total amount of foaming agents needed to produce a foam could be halved. In the composition of the mixture thus produced, the water content was 37.4 w-% and the foaming agent content was 2.6 w-%.

As a result, a mixture having a good foamability was achieved.

### EXAMPLE 5

In an experiment, an adhesive composition was prepared. Phenol-formaldehyde resin (56.8 w-%), filler (18.5 w-%) and ammonium lauryl sulfate (0.5 w-%) and water (24.2 w-%) were mixed together to form a water mixture. The filler was a mixture of starch, chalk, quebracho, potassium carbonate and ammonium sulfate. Alternatively, instead of ammonium lauryl sulfate, it is possible to use sodium lauryl sulfate as a foaming agent.

The mixture thus produced had still better foaming properties and a better stability than the adhesive compositions in examples 1-4.

### EXAMPLE 6

In an experiment, an adhesive composition was prepared. Phenol-formaldehyde resin (65 w-%), filler (11 w-%) and sodium lauryl sulfate (0.9 w-%) and water (23 w-%) were mixed together to form a water mixture. The filler was a mixture of starch and wood powder.

The foaming properties and stability of the mixture thus produced were as good as those of the adhesive composition in example 5.

### EXAMPLE 7

In an experiment, an adhesive composition was prepared. Phenol-formaldehyde resin (50 w-%), filler (28 w-%), a mixture (0.7 w-%) of sodium lauryl sulfate and sodium lauryl ether sulfate and water (21.3 w-%) were mixed together to form a water mixture. The filler was a mixture of starch, wheat meal, sodium carbonate and calcium carbonate.

The mixture thus produced had good foaming properties and a good stability.

### EXAMPLE 8

In an experiment, an adhesive composition was prepared. Phenol-formaldehyde resin (67.5 w-%), filler (12.15 w-%) and sodium lauryl ether sulfate (0.35 w-%) and water (20 w-%) were mixed together to form a water mixture. The filler was a mixture of starch, wheat meal and wood powder.

The foaming properties and stability of the mixture thus produced were as good as those of the adhesive compositions in examples 5 and 6.

### EXAMPLE 9

In an experiment, an adhesive composition was prepared. Phenol-formaldehyde resin (70 w-%), filler (15 w-%) and a foaming agent mixture (3.0 w-%) containing 21% sodium lauryl sulfate, and water (12 w-%) were mixed together to form a water mixture.

The mixture thus produced had good foaming properties.

The adhesive composition of the invention is suited for use as different applications for the manufacture of various wood-based boards.

The embodiments of the invention are not limited to the examples presented above; instead, they may be varied within the scope of the following claims.

1. An Adhesive composition for use in the manufacture of wood-based boards, the adhesive composition comprising 40 to 80 w % of a resin, 5 to 30 w % of a filler, 0.1 to 10 w % of a foaming agent and 0 to 40 w % of a solvent, wherein foaming agent comprises a compound selected from the group consisting of organic or inorganic surface-active sulfate compounds, sulfonate compounds, phosphate compounds, phosphonate compounds, their derivatives and combinations thereof.

2. The adhesive composition of claim 1, wherein the foaming agent comprises a compound selected from the group consisting of lauryl sulfate, lauryl ether sulfate, benzene sulfate, their derivatives and combinations thereof.

3. The adhesive composition of claim 2, wherein the foaming agent comprises a compound selected from the group consisting of sodium lauryl sulfate, ammonium lauryl sulfate, potassium lauryl sulfate, sodium lauryl ether sulfate, ammonium lauryl ether sulfate, potassium lauryl ether sulfate, their derivatives and combinations thereof.

4. The adhesive composition of claim 2, wherein the foaming agent comprises a compound selected from the group consisting of sodium isopropyl sulfonate, sodium lauryl sulfonate, sodium benzene sulfonate, sodium alkyl benzene sulfonate, ammonium lauryl phosphate, ammonium lauryl sulfonate, potassium olein sulfate, sodium naphthalene sulfonate, their derivatives and combinations thereof.

5. The adhesive composition of claim 1 wherein the composition comprises 0.1 to 5 w % foaming agent.

6. The adhesive composition of claim 1 wherein the adhesive composition contains 1 to 10 w % foaming agent, and wherein the foaming agent comprises 0.1 to 30 w % of a compound selected from the group consisting of lauryl sulfate, lauryl ether sulfate, benzene sulfate, their derivatives and combinations thereof.

7. The adhesvie composition of claim 1 wherein the resin is selected from the group consisting of OF, MUF, MUFP, PF, PMF, PRO, their derivatives and combinations thereof.

8. The adhesive composition of claim 1 wherein the composition comprises 50 to 70 w % resin.

9. The adhesive composition of claim 1 wherein the composition comprises 8 to 20 w % filler.

10. The adhesive composition of claim 1 wherein the filler is selected from the group consisting of starch, wheat meal, chalk, sodium carbonate, potassium carbonate, calcium carbonate, ammonium sulfate, wood powder, quebracho, and combinations thereof.

11. The adhesive composition of claim 1 wherein the composition contains 12 to 35 w % solvent.

12. The adhesive composition of claim 1 wherein the solvent is water or an organic solvent.

13. The adhesive composition of claim 1 further comprising added air.

14. The adhesive composition of claim 1 wherein the foaming agent is in solid, liquid or paste-like state.

15. The adhesive composition of claim 1 prepared by a process comprising mixing the resin, filler, foaming agent and solvent to form an emulsion.

16. The adhesive composition of claim 15 wherein the mixing is at a temperature greater than about 40° C.
